(19) United States
(12) Patent Application Publication
(10) Pub. No.: US 2026/0128281 A1
(43) Pub. Date: May 7, 2026

(54) Battery and Manufacturing Method Thereof

(71) Applicant: Semiconductor Energy Laboratory Co., Ltd., Kanagawa-ken (JP)

(72) Inventors: Shunpei YAMAZAKI, Setagaya, Tokyo (JP); Masayuki KIMURA, Atsugi, Kanagawa (JP); Taisuke NAKAO, Atsugi, Kanagawa (JP)

(73) Assignee: Semiconductor Energy Laboratory Co., Ltd., Kanagawa-ken (JP)

(21) Appl. No.: 19/117,853

(22) PCT Filed: Oct. 2, 2023
(86) PCT No.: PCT/IB2023/059842

§ 371 Date: Apr. 2, 2025

(30) Foreign Application Priority Data
Oct. 7, 2022 (JP) 2022-162247

(51) Int. Cl. H01M 4/36; H01M 4/02; H01M 4/38; H01M 4/583

(52) U.S. Cl. CPC H01M 4/364; H01M 4/382; H01M 4/386; H01M 4/583; H01M 2004/027; H01M 2004/028

(57) ABSTRACT

One embodiment of the present invention provides a secondary battery that can be used in a wide temperature range and is not susceptible to the ambient temperature. In addition, a highly safe secondary battery is provided. The secondary battery is manufactured with the use of three kinds or two kinds of conductive additives without using a binder which is an organic resin. As a carbon material that functions as the conductive additive, graphene oxide, graphene oxide subjected to reduction treatment, or a carbon nanotube is selected.

### TECHNICAL FIELD

One embodiment of the present invention relates to a battery and specifically, relates to a secondary battery. The present invention is not limited to the above field and relates to a semiconductor device, a display device, a light-emitting device, a power storage device, a lighting device, an electronic device, a vehicle, and manufacturing methods thereof. The secondary battery of one embodiment of the present invention can be used as a power supply necessary for the above semiconductor device, display device, light-emitting device, power storage device, lighting device, electronic device, and vehicle. Examples of the above electronic device include an information terminal device provided with the secondary battery. Furthermore, examples of the above power storage device include a stationary power storage device.

### BACKGROUND ART

Among batteries, secondary batteries can be used repeatedly by being charged or discharged, and are also called storage batteries. Secondary batteries using lithium ions as carrier ions, which are called lithium-ion secondary batteries, can have a higher capacity and a smaller size and are under intensive research and development.

One of the problems for secondary batteries is their susceptibility to the ambient temperature. For example, a decrease in the ambient temperature leads to a higher viscosity of an electrolyte of a secondary battery, which degrades carrier ion conducting performance. Degraded performance of an electrolyte causes degradation of capabilities, such as an increase in internal resistance, of a secondary battery.

Examples of vehicles with motors driven by secondary batteries include electric vehicles; it has been difficult to spread electric vehicles to cold climate areas or tropical regions because of influences of ambient temperatures such as cold temperatures or hot temperatures on an electrolyte.

Examples of vehicles including secondary batteries include, in addition to electric vehicles, hybrid vehicles having two power sources of an engine and a motor. Hybrid vehicles include plug-in hybrid vehicles that can be charged from outlets. Examples of electronic devices including secondary batteries include portable information terminals such as mobile phones, smartphones, and laptop personal computers, portable music players, digital cameras, and medical instruments.

It is desired that the secondary batteries included in electric vehicles, hybrid vehicles, plug-in hybrid vehicles, or electronic devices can demonstrate stable performance irrespective of the ambient temperature at which the secondary batteries are used. In addition, the secondary batteries are required to be much safer.

Patent Document 1 discloses a positive electrode active material layer or a negative electrode active material layer including graphene.

### REFERENCE

### Patent Document

[Patent Document 1] Japanese Published Patent Application No. 2016-192414

### SUMMARY OF THE INVENTION

### Problems to be Solved by the Invention

A lithium-ion secondary battery has a problem in charging and discharging at low temperatures or high temperatures. A secondary battery is a power storage means utilizing a chemical reaction and thus has a difficulty in exhibiting sufficient performance at low temperatures especially below the freezing point. Moreover, at high temperatures, the lifetime of a lithium-ion secondary battery might be shorter and abnormality might occur.

A secondary battery that can exhibit stable performance regardless of the ambient temperature in use or storage has been desired.

One object of one embodiment of the present invention is to provide a secondary battery that can be used in a wide temperature range and is not susceptible to the ambient temperature.

Note that the description of these objects does not preclude the existence of other objects. Note that one embodiment of the present invention does not necessarily achieve all these objects. Note that other objects can be derived from the description of the specification, the drawings, and the claims.

### Means for Solving the Problems

The structure disclosed in this specification is a battery including a positive electrode active material layer including lithium; and a negative electrode active material layer including graphite, silicon, graphene, and a carbon nanotube. The silicon and the graphene are at least partly in contact with each other, and the silicon and the carbon nanotube are at least partly in contact with each other.

In this structure, graphite and silicon particles are used as negative electrode active materials. The silicon particles refer to silicon powders that are negative electrode active materials of lithium-ion secondary batteries and have an average grain diameter in particle size distribution, that is, an average particle diameter, of around 100 nm; the silicon particles are referred to as nanosilicon particles in some cases. In order to obtain the silicon particles to be used, it is preferable that a silicon source material be ground and particle diameters be adjusted to be uniform. The silicon particles may include at least one of silicon, silicon oxide, and a silicon alloy.

In the above structure, it is preferable that an average particle diameter of the graphite particles to be mixed with the silicon particles be greater than or equal to 1 μm, further preferably greater than or equal to 5 μm and less than or equal to 30 μm. The particle size can be typically measured using laser diffraction particle size distribution measurement; however, without limitation to the laser diffraction particle size distribution measurement, the major axis of the particle's cross section may be measured by analysis using a scanning electron microscope (SEM), TEM (a transmission electron microscope), or the like.

In this specification, at least both graphite particles and silicon particles are included as negative electrode active materials. Since the silicon particles are mixed and used in a negative electrode, a secondary battery with a high energy density can be obtained.

When the silicon particles expand when occluding lithium ions, leading to volume expansion. Since there is a space between graphite and its adjacent graphite and silicon particles are positioned between the graphite, the negative electrode active material layer is hardly affected as a whole even when the silicon particles occlude lithium ions and expand. The silicon particles are aggregated in some of the spaces that are between graphite. These spaces are present at the phase at which the negative electrode active material layer is formed over a negative electrode current collector; the spaces are filled with an electrolyte solution in a later step of the manufacturing process of the secondary battery.

In order to obtain a secondary battery capable of being charged or discharged even at low temperatures, the average particle diameter of active material particles of a positive electrode is made smaller than the average particle diameter of graphite. When the average particle diameter of positive electrode active material particles is less than or equal to 20 μm, which is the average particle diameter of the graphite, the capacity per volume is increased. Specifically, the average particle diameter of the graphite particles is greater than or equal to 5 μm, preferably greater than or equal to 10 μm, and the average particle diameter of the positive electrode active material is less than or equal to 20 μm, preferably less than 5 μm.

Note that the weight ratio in this specification refers to the compounding ratio at the time of manufacturing electrode slurry described later, i.e., the weight ratio (wt %) of each of an active material and a conductive additive in the total weight (the mixed powder). Therefore, each weight ratio is sometimes different between before and after a secondary battery is manufactured.

Specifically, the silicon weight ratio in the total weight of the powder materials included in the negative electrode active material is greater than or equal to 7.5 wt % and less than or equal to 37.5 wt %. The negative electrode active material layer has a feature that the weight ratio of the graphite particles is greater than the weight ratio of the silicon particles.

Another feature is that when the negative electrode active material layer is formed, a material that functions as a binding agent and a conductive additive is added. Typical examples of a carbon material that functions as a binding agent and a conductive additive include graphene, graphene oxide, graphene oxide subjected to reduction treatment, and a carbon nanotube. The conductive additive (graphene, graphene oxide, graphene oxide subjected to reduction treatment, or a carbon nanotube) is attached to or adsorbed on the surface of the graphite or the surface of the silicon particles. Alternatively, the conductive additive (graphene, graphene oxide, graphene oxide subjected to reduction treatment, or a carbon nanotube) is chemically bonded to the surface of the graphite or the surface of the silicon particles. Conductive additives of different kinds are attached to or adsorbed to each other. Alternatively, conductive additives of different kinds are chemically bonded to each other.

As the conductive additive for electrically connecting the current collector and the active material particles, one or more of graphene, graphene oxide, graphene oxide subjected to reduction treatment, and a carbon nanotube are used. With the use of a plurality of kinds of conductive additives, e.g., two or more kinds of conductive additives, the plurality of kinds of conductive additives are in contact with the active material particles, surround at least part of the surface of the active material particles, prevent detachments, and form an electron conduction path between the active material particles.

Note that graphene in this specification has a carbon hexagonal lattice structure and includes single-layer graphene or multilayer graphene including two to one hundred layers. The single-layer graphene (one graphene) refers to a one-atom-thick sheet of carbon molecules having sp² hybrid orbitals. FIG. 12 shows a SEM photograph of graphene as an example of a material of the conductive additive. A plurality of graphene refers to multilayer graphene or a plurality of single-layer graphene. Graphene is not limited to being formed of only carbon, may be partly bonded to oxygen, hydrogen, or a functional group, and can also be referred to as a graphene compound. The graphene compound sometimes has excellent electrical characteristics of high conductivity and excellent physical properties of high flexibility and high mechanical strength. The graphene compound has a planar shape. The graphene compound enables low-resistance surface contact. Furthermore, the graphene compound sometimes has an extremely high conductivity even with a small thickness, and thus a small quantity of the graphene compound allows a conductive path to be formed efficiently in the active material layer.

The graphene compound can cling to the active materials like fermented soybeans; thus, the graphene compound can also function as a binder for bonding the active materials. Thus, the quantity of the binder which is a resin material can be made extremely small, or the secondary battery can be manufactured without the use of any binders which are resin materials; thus, the proportion of the active materials in the electrode volume or the electrode weight can be increased. That is, the capacity per unit volume of the secondary battery can be increased.

Specifically, a battery in which the content of a resin material is lower than the content of silicon in a negative electrode active material layer (greater than or equal to 7.5 wt % and less than or equal to 37.5 wt % as described above) or a battery which does not include a resin material in a negative electrode active material layer is manufactured.

FIG. 12 shows a SEM photograph of graphene oxide as an example of a material of the conductive additive. The graphene oxide includes six-membered rings each composed of carbon atoms, which are spread in the planar direction, and poly-membered rings such as a seven-membered ring, an eight-membered ring, a nine-membered ring, and a ten-membered ring are included as some of the six-membered rings. Note that a poly-membered ring refers to a ring-shaped carbon skeleton formed when a carbon bond in part of a six-membered ring composed of carbon atoms is broken and the broken carbon bond is bonded so that the number of carbon atoms is increased. A region surrounded with carbon atoms in the poly-membered ring is a space.

FIG. 13 shows a SEM photograph of graphene oxide subjected to reduction treatment as an example of a material of the conductive additive. Performing reduction treatment on graphene oxide can form a hole in the graphene compound in some cases. FIG. 6A, FIG. 6B, and FIG. 6C each illustrate an example of a structure of graphene provided with a hole.

In FIG. 6A, graphene includes a hole formed by 18 carbon atoms bonded in a ring. Six carbon atoms of the 18 carbon atoms each have a bond with hydrogen. In FIG. 6A, an 18-membered ring composed of carbon atoms is illustrated and six carbon atoms of the carbon atoms included in the 18-membered ring are each terminated by hydrogen. In the structure illustrated in FIG. 6A, one six-membered ring is removed from graphene and carbon atoms bonded to the removed six-membered ring are terminated by hydrogen.

In FIG. 6B, graphene includes a hole formed by 22 carbon atoms bonded in a ring. Eight carbon atoms of the 22 carbon atoms each have a bond with hydrogen. In FIG. 6B, a 22-membered ring of carbon atoms is illustrated and eight carbon atoms of the carbon atoms included in the 22-membered ring are each terminated by hydrogen. In the structure illustrated in FIG. 6B, two connected six-membered rings are removed from graphene and carbon atoms bonded to the removed six-membered rings are terminated by hydrogen.

In FIG. 6C, graphene includes a hole formed by 24 carbon atoms bonded in a ring. Nine carbon atoms of the 24 carbon atoms each have a bond with hydrogen. In FIG. 6C, a 24-membered ring of carbon atoms is illustrated and nine carbon atoms of the carbon atoms included in the 24-membered ring are each terminated by hydrogen. The graphene illustrated in FIG. 6C has a structure in which three connected six-membered rings are removed from graphene and carbon atoms bonded to the removed six-membered rings are terminated by hydrogen.

When both a graphene compound (graphene, graphene oxide, and graphene oxide subjected to reduction treatment) and a carbon nanotube are used as the conductive additives, the manufacturing cost can be reduced as compared with the case where only a carbon nanotube is used.

There are a plurality of kinds of carbon nanotubes. A single-walled carbon nanotube (SWNT) is a seamless cylindrical substance formed of single-layer graphene. A multi-walled carbon nanotube (MWNT) can be subjected to surface modification, and only the exterior of the multi-walled carbon nanotube is chemically modified; thus, intrinsic properties in the multi-walled carbon nanotube are maintained. A double-walled carbon nanotube (DWNT) is composed of two concentric nanotubes and has intermediate characteristics of the SWNT and the MWNT.

Although part of the carbon nanotube may be chemically modified, bonds that form the carbon nanotube might be significantly broken in the case where the degree of modification is large, whereby part or the whole of the properties of the carbon nanotube is lost; thus, the treatment by a chemical modification method is preferably adjusted as appropriate.

Note that the fiber diameter of the carbon nanotube was obtained by observing the carbon nanotube with a SEM (scanning electron microscope), calculating the fiber diameters of a plurality of carbon fibers in the obtained SEM image, and number-averaging the obtained fiber diameters. The length of the carbon nanotube was obtained by observing the carbon nanotube with a SEM, calculating the fiber lengths of a plurality of carbon fibers in the obtained SEM image, and number-averaging the obtained fiber lengths.

The carbon nanotube has a length greater than or equal to 300 nm and less than or equal to 700 μm, and has a fiber diameter greater than or equal to 0.5 nm and less than or equal to 20 nm. FIG. 14 shows a SEM photograph of a single-walled carbon nanotube having a length of 600 um as an example of a material of the conductive additive. The above length is a numerical value at the phase at which a material is prepared, and when a carbon nanotube with a length greater than or equal to 100 μm is mixed with the graphite or the silicon particles, the carbon nanotube is sometimes cut into less than 100 μm at the time of mixing.

In addition, acetylene black (AB) may be used as one kind of the conductive additive. Acetylene black (AB) is attached to or adsorbed on the surface of the graphite or the surface of the silicon particles. Alternatively, acetylene black (AB) is chemically bonded to the surface of the graphite or the surface of the silicon particles. Acetylene black (AB) and conductive additives of different kinds (graphene, graphene oxide, graphene oxide subjected to reduction treatment, or a carbon nanotube) are attached or adsorbed to each other. Alternatively, acetylene black (AB) and conductive additives of different kinds (graphene, graphene oxide, graphene oxide subjected to reduction treatment, or a carbon nanotube) are chemically bonded to each other.

A structure may be employed in which a graphene compound is included not only in the negative electrode active material layer but also in the positive electrode active material layer. A carbon nanotube may be included in the positive electrode active material layer instead of the graphene compound. Graphene oxide or graphene oxide subjected to reduction treatment may be included in the positive electrode active material layer instead of graphene or in combination with graphene.

The positive electrode active material layer includes an active material that functions as a positive electrode active material and further includes a conductive additive. There is no particular limitation on the material of the positive electrode active material used for the positive electrode active material layer. The material of the positive electrode active material is not limited to lithium composite oxide represented by LiMₓO_{y} (x>0 and y>0, more specifically, y=2 and 0.8<x<1.2, for example) typified by lithium cobalt oxide; a NiCo-based material represented by LiNiₓCo₁₋ₓO₂ (0<x<1), lithium composite oxide represented by LiMₓO_{y}, e.g., a NiMn-based material represented by LiNiₓMn₁₋ₓO₂ (0<x<1) can be used as the material of the positive electrode active material. Alternatively, a NiCoMn-based material (also referred to as NCM) represented by LiNiₓCo_{y}Mn_{z}O₂ (x>0, y>0, 0.8<x+y+z<1.2) can be used as the material of the positive electrode active material. Specifically, for example, 0.1x<y<8x and 0.1x<z<8x are preferably satisfied. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof. Lithium iron phosphate (LiFePO₄) may be used as the positive electrode active material.

Since the binder which is a resin material is an insulator, the quantity of the resin material is preferably small. In this specification, a resin material refers to a high molecular material that is also an organic material with a high insulating property. In this specification, a binder is unnecessary as long as the negative electrode active material layer can be formed without using an organic resin when a binder which is an organic resin is not used in the negative electrode. In that case, a battery in which the negative electrode active material layer does not include a resin material can be obtained.

However, in order to improve adhesion with the negative electrode current collector, a very small quantity of a binder which is a resin material may be added. Note that the content of the resin material is preferably smaller than the content of silicon in the negative electrode active material layer.

A thickener may be added at the time of manufacturing the slurry in the case where application cannot be performed.

### EFFECTS OF THE INVENTION

According to one embodiment of the present invention, conductivity of a negative electrode active material layer is improved when a binder that is a resin material is eliminated, and a negative electrode that enables a lithium-ion secondary battery to have excellent charge and discharge capacity and excellent charge and discharge cycle performance when used for the lithium-ion secondary battery can be provided. Alternatively, a highly safe or highly reliable secondary battery can be provided.

Furthermore, the conductivity of the negative electrode active material layer is improved according to one embodiment of the present invention, so that a secondary battery capable of being charged or discharged even at low temperatures can be obtained.

Furthermore, one embodiment of the present invention can provide a negative electrode active material, a negative electrode mixed material, a negative electrode active material layer, and a secondary battery including the negative electrode active material, the negative electrode mixed material, the negative electrode active material layer, or manufacturing methods thereof.

Note that the description of these effects does not preclude the existence of other effects. Note that one embodiment of the present invention does not necessarily have all these effects. Note that other effects will be apparent from the description of the specification, the drawings, the claims, or the like, and other effects can be derived from the description of the specification, the drawings, the claims, and the like.

### BRIEF DESCRIPTION OF THE DRAWINGS

FIG. 1 is a schematic cross-sectional view of a negative electrode, showing one embodiment of the present invention.

FIG. 2 is a diagram illustrating an example of a flow chart of a manufacturing process of a negative electrode active material layer, showing one embodiment of the present invention.

FIG. 3 is a schematic cross-sectional view of a secondary battery, showing one embodiment of the present invention.

FIG. 4 is a diagram illustrating an example of a flow chart of a manufacturing process of a negative electrode active material layer, showing one embodiment of the present invention.

FIG. 5 is a diagram illustrating an example of a flow chart of a manufacturing process of a negative electrode active material layer, showing one embodiment of the present invention.

FIG. 6A, FIG. 6B, and FIG. 6C are diagrams each illustrating an example of a graphene compound.

FIG. 7A is an exploded perspective view of a coin-type secondary battery, FIG. 7B is a perspective view of the coin-type secondary battery, and FIG. 7C is a cross-sectional perspective view thereof.

FIG. 8A and FIG. 8B are diagrams each illustrating external views of a secondary battery.

FIG. 9A to FIG. 9C are diagrams illustrating a method for manufacturing a secondary battery.

FIG. 10A to FIG. 10D are diagrams each illustrating an example of an electronic device.

FIG. 11A to FIG. 11D are diagrams each illustrating an example of a device for space.

FIG. 12 is a photograph showing an example of a material of a negative electrode active material layer.

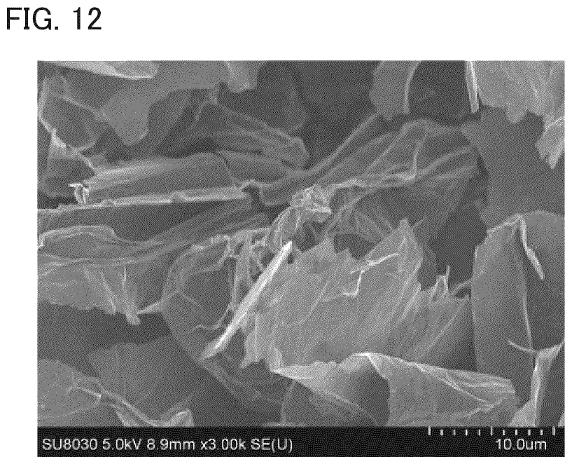

FIG. 13 is a photograph showing an example of a material of a negative electrode active material layer.

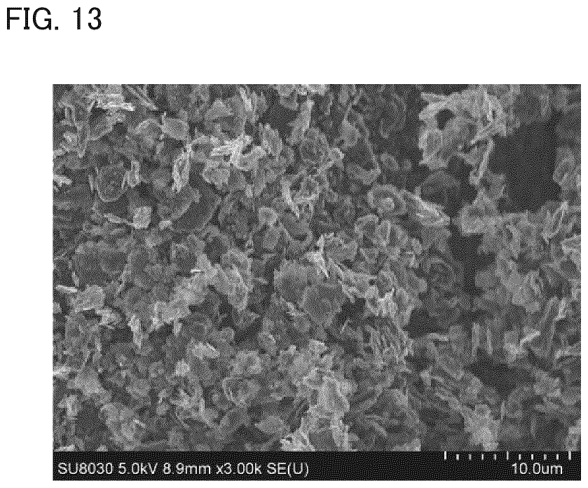

FIG. 14 is a photograph showing an example of a material of a negative electrode active material layer.

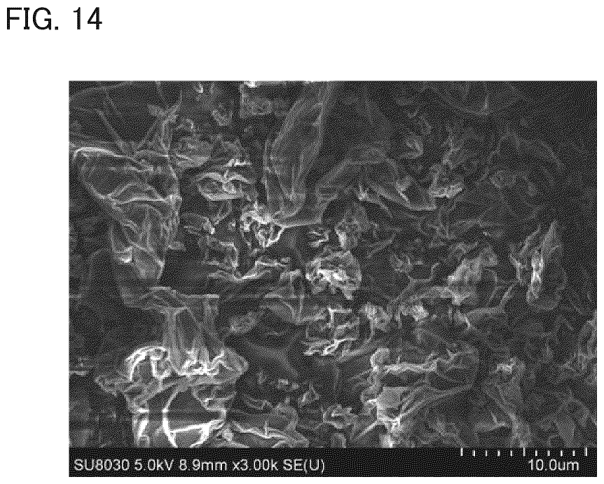

FIG. 15 is a photograph showing an example of a material of a negative electrode active material layer.

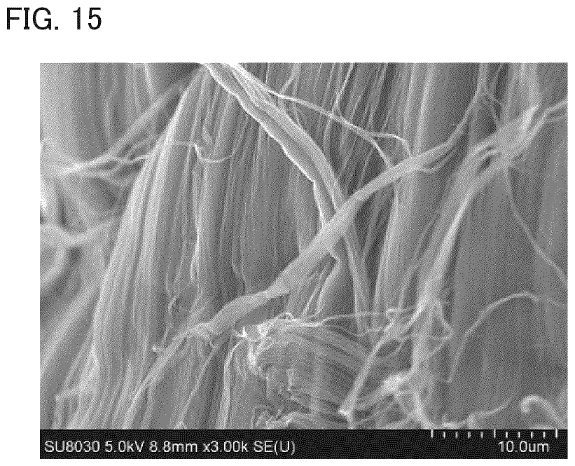

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

In this embodiment, an example of a negative electrode active material layer and an example of a method for manufacturing a negative electrode including the negative electrode active material layer will be described below.

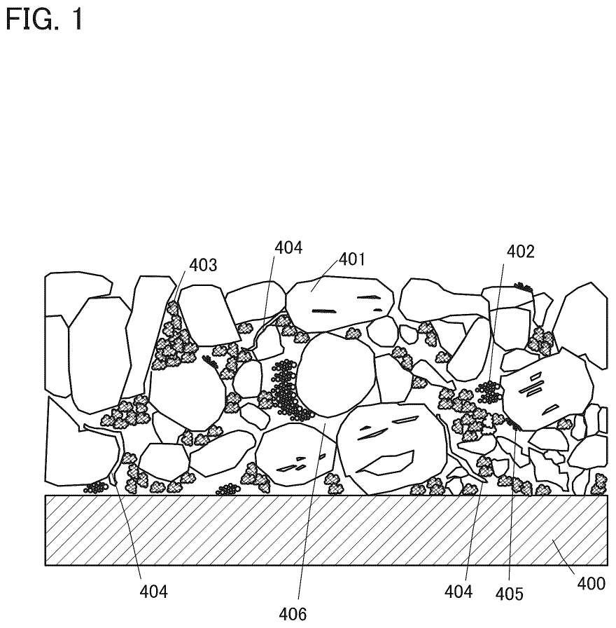

FIG. 1 illustrates a schematic cross-sectional view of the negative electrode active material layer of this embodiment.

FIG. 1 is an example of a schematic cross-sectional view of a phase at which slurry is applied onto a negative electrode current collector 400 and the negative electrode active material layer is formed; three kinds of conductive additives are used. The negative electrode active material layer includes graphite 401, silicon particles 402, acetylene black (AB) 403, graphene 404, CNT (carbon nanotube) 405, and a space 406.

The acetylene black 403 and the graphite 401 are provided in contact with the surface of the negative electrode current collector 400 that is a copper foil. The average particle diameter of the silicon particles 402 is small; a plurality of the silicon particles are aggregated and scattered in the negative electrode active material layer. The graphene 404 is provided in contact with a surface of the graphite 401, and the CNT 405 is also provided in contact with the surface of the graphite 401. The silicon particles 402 are provided in contact with the surface of the graphite 401. For example, silicon particles having a particle diameter of 100 nm (product number 633097 manufactured by Sigma-Aldrich Co., LLC) are used.

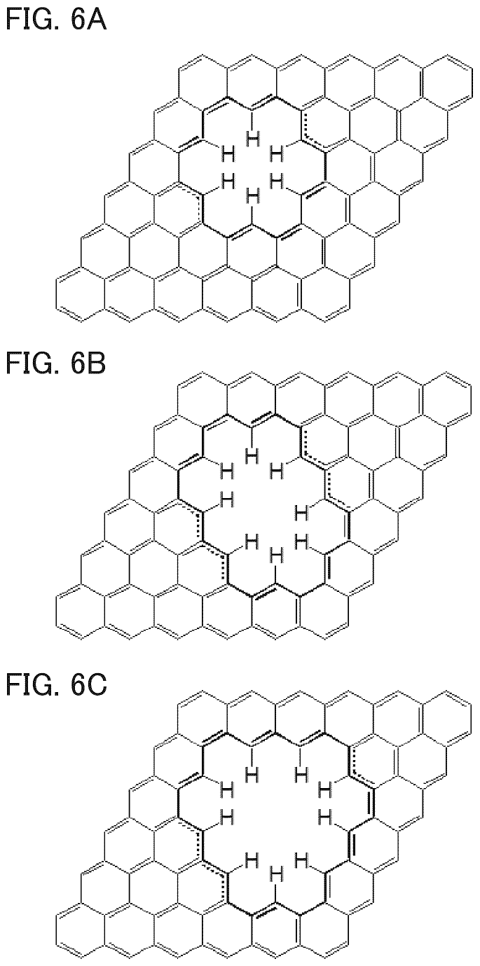

As the graphite 401, graphite (FormulaBT 1520T manufactured by Superior Graphite Co.) having an average particle diameter of approximately 20 μm is used. This graphite is obtained by coating spherical natural graphite with low crystalline carbon. The weight ratio of the graphite 401 to the silicon particles in the negative electrode active material layer is 9:1. That is, in this case, the weight ratio of the silicon particles 402 in the total weight of the powder materials included in the negative electrode active material is approximately 10 wt %. The silicon particles 402 expand or contract at the time of charging or discharging; using a large quantity of the silicon particles leads to an increase in capacity and leads to a decrease in cycle performance, on the other hand. Accordingly, the silicon weight ratio in the total weight of the powder materials included in the negative electrode active material is within a range of greater than or equal to 7.5 wt % and less than or equal to 37.5 wt %. The weight ratio of the graphene 404 in the total weight of the powder materials included in the negative electrode active material is approximately 1 wt %. As the graphene 404, graphene provided with a hole illustrated in FIG. 6A, FIG. 6B, or FIG. 6C may be used.

The weight ratio of the CNT 405 in the total weight of the powder materials included in the negative electrode active material is approximately 1 wt %. As the CNT 405, for example, a single-walled carbon nanotube, SG101, manufactured by ZEON Corporation is used. The weight ratio of the acetylene black 403 in the total weight of the powder materials included in the negative electrode active material is approximately 6 wt %.

In FIG. 1, a binder which is a resin material is not used for the negative electrode active material layer.

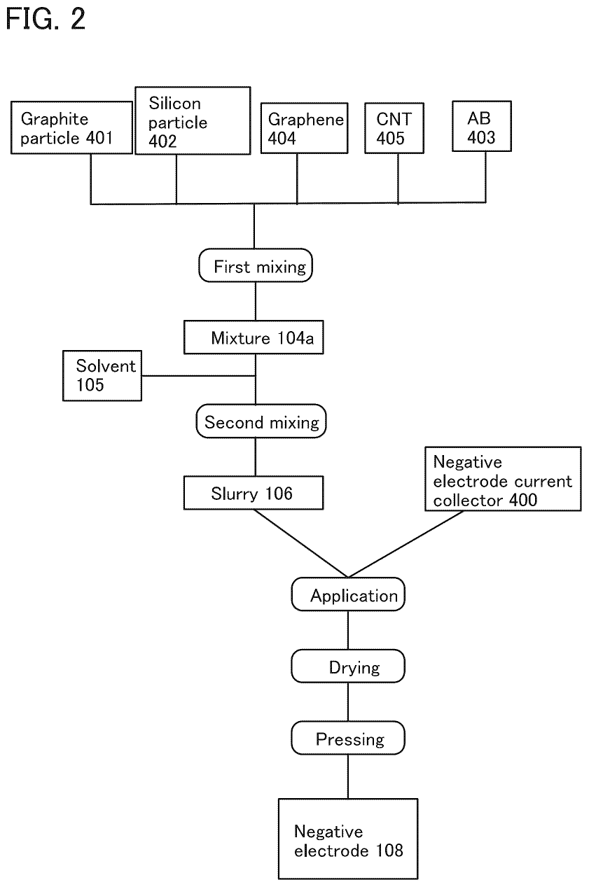

FIG. 2 shows an example of a manufacturing flow of the negative electrode active material layer of this embodiment.

First, each of the graphite particles 401, the silicon particles 402, the acetylene black 403, the graphene 404, and the CNT 405 is weighed so as to have a desired quantity of powder, and first mixing is performed. The silicon particles 402 are preferably used for the negative electrode such that the silicon particles are not oxidized, and mixing treatment is preferably performed such that the silicon particles are not oxidized also in the first mixing.

A solvent 105 is added to a mixture 104a obtained by the first mixing, and second mixing is performed. Deionized water, for example, is used as the solvent 105.

By the second mixing, slurry 106 can be manufactured. Then, the slurry is applied onto the negative electrode current collector 400. The slurry is applied onto one surface or both surfaces of the negative electrode current collector 400 as necessary.

Then, drying is performed, and pressing is performed if necessary. The pressure of a press machine is preferably a linear pressure lower than or equal to 500 kN/m, further preferably a linear pressure lower than or equal to 300 kN/m, still further preferably a linear pressure lower than or equal to 250 kN/m, for example. During pressure application with the use of the press machine, rollers are preferably heated.

Through the above steps, a negative electrode 108 including the negative electrode active material layer over the negative electrode current collector 400 can be formed without the use of a binder which is a resin material.

Note that in the case of manufacturing a half cell, a coin-type secondary battery is manufactured in which a lithium foil is used as one of electrodes and a separator is placed therebetween. Note that an electrolyte solution is introduced so that the spaces 406 are filled with the electrolyte solution. The electrolyte solution is a liquid electrolyte, and as the electrolyte, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio. As an organic solvent of the electrolyte solution, an aprotic organic solvent is preferable. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these can be used in an appropriate combination at an appropriate ratio. The use of one or more ionic liquids (room temperature molten salts) which have non-flammability and non-volatility as the solvent of the electrolyte solution can prevent a power storage device from exploding, catching fire, and the like even when the power storage device internally short outs or the internal temperature increases owing to overcharging or the like. An ionic liquid includes a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### Embodiment 2

A secondary battery is manufactured with the use of the negative electrode described in Embodiment 1. In this embodiment, an example of a secondary battery called a full cell, i.e., a battery including a positive electrode active material layer and a negative electrode active material layer, is described below.

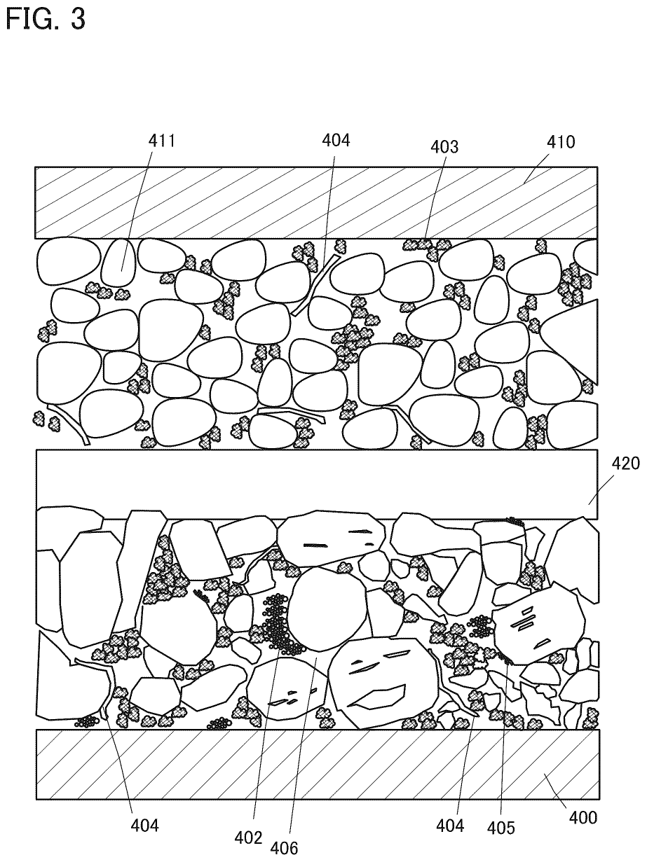

FIG. 3 is a schematic cross-sectional view of the secondary battery of this embodiment. Note that portions that are the same as those in FIG. 1 are denoted by the same reference numerals and the description thereof is omitted.

As illustrated in FIG. 3, a separator 420 is provided over the negative electrode described in Embodiment 1, and a positive electrode is provided thereover.

Since the negative electrode of the secondary battery in FIG. 3 has the same structure as that in FIG. 1, the same reference numerals are used for the same materials as those in FIG. 1.

The positive electrode includes a positive electrode active material layer including a positive electrode active material 411 on one surface or both surfaces of a positive electrode current collector 410. The positive electrode active material 411 with an average particle diameter smaller than that of graphite is used as an example of a material used for the positive electrode active material layer, and here, a lithium cobalt compound with an average particle diameter of 5 μm is used as the positive electrode active material 411. The positive electrode active material layer includes the graphene 404 and the acetylene black 403. The positive electrode active material layer is also formed without the use of a binder which is an organic resin. Accordingly, in the structure illustrated in FIG. 3, a binder which is an organic resin is not used for both the negative electrode active material layer and the positive electrode active material layer, whereby the capacity per volume can be increased.

FIG. 3 illustrates the spaces 406 and illustrates a cross-sectional structure in a state before the electrolyte solution is introduced.

In the case where the secondary battery is manufactured using a stack of the negative electrode, the separator 420, and the positive electrode illustrated in FIG. 3, the secondary battery is sealed with the use of a sealant for a coin cell or a laminate cell, and an electrolyte solution is introduced in the inside.

In the case where the capacity of the secondary battery is increased, adjustment can be made by increasing the number of stacked layers of the stack or the electrode area.

This embodiment can be freely combined with the other embodiments.

### Embodiment 3

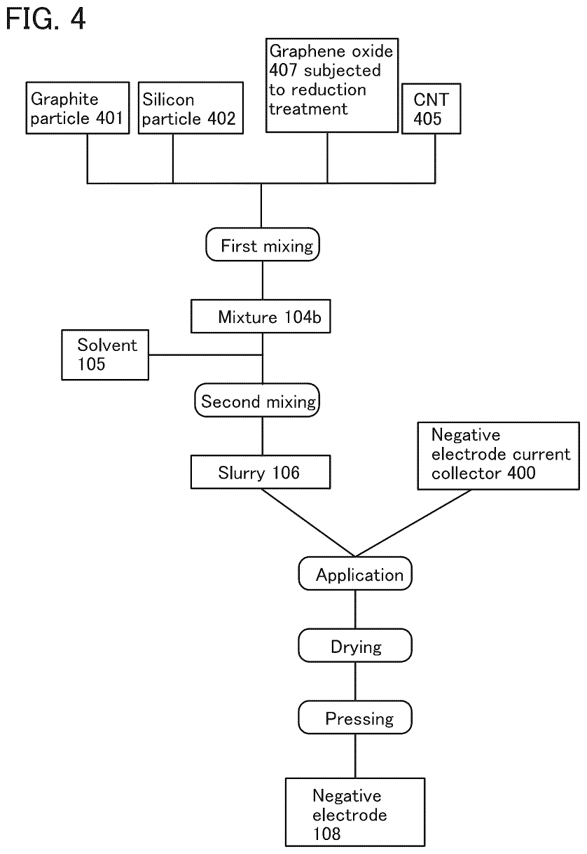

FIG. 4 shows an example of a formation flow of the negative electrode active material layer of this embodiment.

The conductive additives used for the negative electrode are partly different from those in Embodiment 1. The others are the same; thus, the detailed description thereof is omitted.

Although three kinds of conductive additives are used in the example described in Embodiment 1, two kinds of conductive additives are used for the negative electrode in this embodiment.

First, each of the graphite particles 401, the silicon particles 402, graphene oxide 407 subjected to reduction treatment, and the CNT 405 is weighed so as to have a desired quantity of powder, and first mixing is performed. The silicon particles 402 are preferably used for the negative electrode such that the silicon particles are not oxidized, and mixing treatment is preferably performed such that the silicon particles are not oxidized also in the first mixing.

The solvent 105 is added to a mixture 104b obtained by the first mixing, and second mixing is performed. Deionized water, for example, is used as the solvent 105.

By the second mixing, the slurry 106 can be manufactured. Then, the slurry is applied onto the negative electrode current collector 400. The slurry is applied onto one surface or both surfaces of the negative electrode current collector 400 as necessary.

Then, drying is performed, and pressing is performed if necessary. The pressure of a press machine is preferably a linear pressure lower than or equal to 500 kN/m, further preferably a linear pressure lower than or equal to 300 kN/m, still further preferably a linear pressure lower than or equal to 250 kN/m, for example. During pressure application with the use of the press machine, rollers are preferably heated.

Through the above steps, the negative electrode 108 including a negative electrode active material layer over the negative electrode current collector 400 can be formed without the use of a binder which is a resin material.

This embodiment can be freely combined with the other embodiments. For example, acetylene black may be added as appropriate or graphene oxide may be added as appropriate in the first mixing. Both acetylene black and graphene oxide may be added as appropriate.

### Embodiment 4

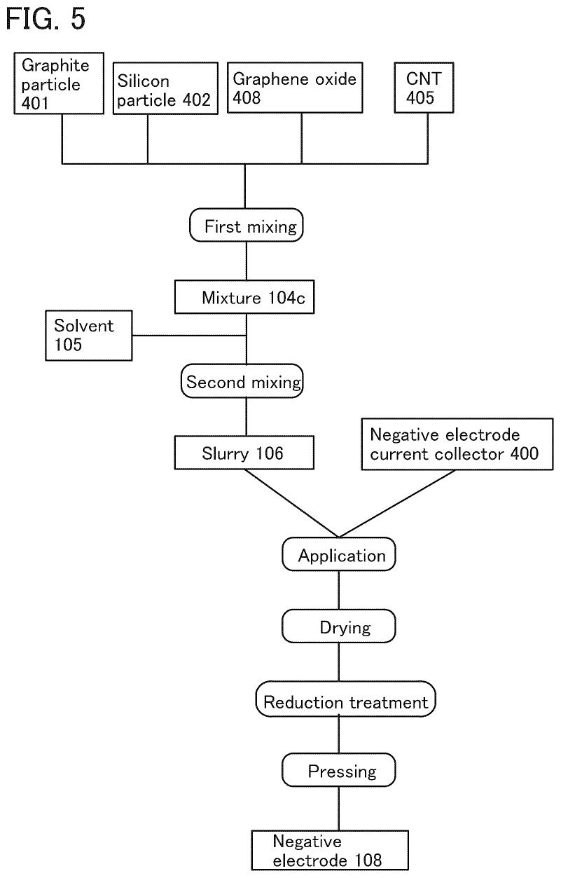

FIG. 5 shows an example of a manufacturing flow of the negative electrode active material layer of this embodiment.

The conductive additives used for the negative electrode are partly different from those in Embodiment 1. The others are the same; thus, the detailed description thereof is omitted.

Although three kinds of conductive additives are used in the example described in Embodiment 1, two kinds of conductive additives are used for the negative electrode in this embodiment.

First, each of the graphite particles 401, the silicon particles 402, graphene oxide 408, and the CNT 405 is weighed so as to have a desired quantity of powder, and first mixing is performed. The silicon particles 402 are preferably used for the negative electrode such that the silicon particles are not oxidized, and mixing treatment is preferably performed such that the silicon particles are not oxidized also in the first mixing.

The solvent 105 is added to a mixture 104c obtained by the first mixing, and second mixing is performed. Deionized water, for example, is used as the solvent 105.

By the second mixing, the slurry 106 can be manufactured. Then, the slurry is applied onto the negative electrode current collector 400. The slurry is applied onto one surface or both surfaces of the negative electrode current collector 400 as necessary.

Then, drying is performed, followed by reduction treatment. Performing reduction treatment on the graphene oxide can form a hole in a graphene compound in some cases.

Note that the reduction treatment of the graphene oxide may be performed by heat treatment or with the use of a reducing agent. Both treatment (the heat treatment and the reducing agent) may be performed on the graphene oxide.

After the reduction treatment of the graphene oxide, pressing is performed if necessary. The pressure of a press machine is preferably a linear pressure lower than or equal to 500 kN/m, further preferably a linear pressure lower than or equal to 300 kN/m, still further preferably a linear pressure lower than or equal to 250 kN/m, for example. During pressure application with the use of the press machine, rollers are preferably heated.

Through the above steps, the negative electrode 108 including a negative electrode active material layer over the negative electrode current collector 400 can be formed without the use of a binder which is a resin material.

This embodiment can be freely combined with the other embodiments.

### Embodiment 5

In this embodiment, examples of the shape of a secondary battery including the negative electrode manufactured by the manufacturing method described in Embodiment 1 will be described.

### [Coin-type Secondary Battery]

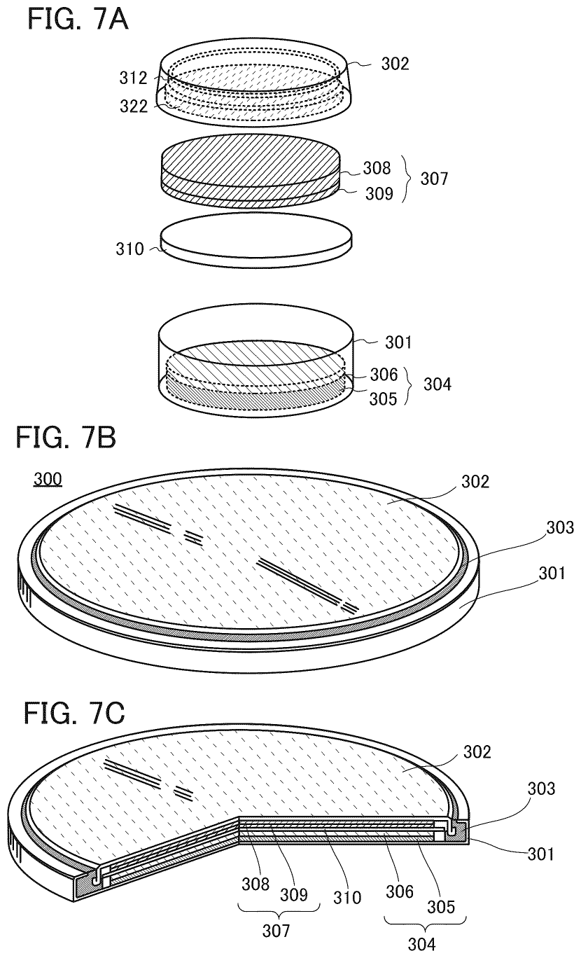

An example of a coin-type secondary battery will be described. FIG. 7A is an exploded perspective view of a coin-type (single-layer flat type) secondary battery, FIG. 7B is an external view thereof, and FIG. 7C is a cross-sectional view thereof. Coin-type secondary batteries are mainly used in small electronic devices.

Note that for easy understanding, FIG. 7A is a schematic view illustrating overlap (a vertical relation and a positional relation) between components. Thus, FIG. 7A and FIG. 7B do not completely correspond with each other.

In FIG. 7A, a positive electrode 304, a separator 310, a negative electrode 307, a spacer 322, and a washer 312 are overlaid. They are sealed with a negative electrode can 302, a positive electrode can 301, and a gasket. Note that a gasket for sealing is not illustrated in FIG. 7A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 7B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene. The positive electrode 304 is formed of the positive electrode current collector 305 and the positive electrode active material layer 306 provided in contact with the positive electrode current collector 305. The negative electrode 307 is formed of a negative electrode current collector 308 and a negative electrode active material layer 309 provided in contact with the negative electrode current collector 308. The negative electrode 307 is not limited to having a stacked-layer structure, and a lithium metal foil or an alloy foil of lithium metal and aluminum may be used.

Note that only one surface of each of the positive electrode 304 and the negative electrode 307 used for the coin-type secondary battery 300 is provided with an active material layer. The negative electrode 307 can be obtained by the manufacturing method described in Embodiment 1. The positive electrode 304 can be obtained by the manufacturing method described in Embodiment 2.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel or aluminum in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in an electrolyte solution or an ionic liquid; the positive electrode 304, the separator 310, the negative electrode 307, and the negative electrode can 302 are stacked in this order with the positive electrode can 301 positioned at the bottom as illustrated un FIG. 7C; and the positive electrode can 301 and the negative electrode can 302 are subjected to pressure bonding with the gasket 303 therebetween.

As the separator 310, for example, fiber including cellulose such as paper; nonwoven fabric; glass fiber; ceramics; or synthetic fiber using a nylon resin (polyamide), a vinylon resin (polyvinyl alcohol-based fiber), a polyester resin, an acrylic resin, a polyolefin resin, or a polyurethane resin can be used.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with a polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

With the above structure, the coin-type secondary battery 300 can be obtained without the use of a binder which is an organic resin.

### [Laminated Secondary Battery]

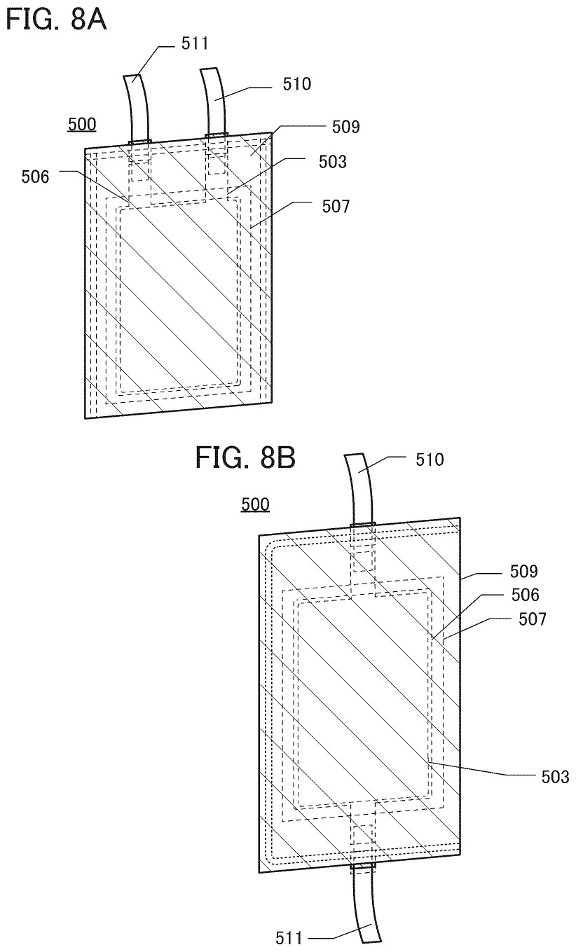

Next, examples of the external views of a laminated secondary battery are illustrated in FIG. 8A and FIG. 8B. In FIG. 8A and FIG. 8B, a positive electrode 503, a negative electrode 506, a separator 507, an exterior body 509, a positive electrode lead electrode 510, and a negative electrode lead electrode 511 are included.

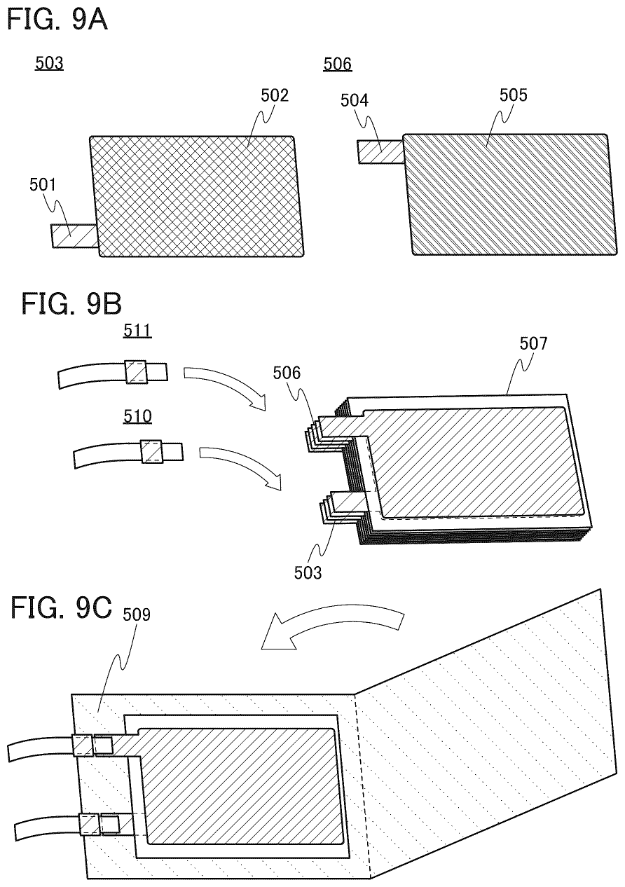

FIG. 9A illustrates the appearance of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples illustrated in FIG. 9A.

### [Method for Manufacturing Laminated Secondary Battery]

An example of a method for manufacturing the laminated secondary battery whose external view is illustrated in FIG. 8A will be described with reference to FIG. 9B and FIG. 9C.

First, the negative electrode 506, the separator 507, and the positive electrode 503 are stacked. FIG. 9B illustrates the negative electrodes 506, the separators 507, and the positive electrodes 503 which are stacked. Here, an example in which five negative electrodes and four positive electrodes are used is illustrated. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line, as illustrated in FIG. 9C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

When the negative electrode active material layer obtained in Embodiment 1 is used for the negative electrode 506, the secondary battery 500 can be manufactured without the use of a binder which is an organic resin. This embodiment can be freely combined with the other embodiments.

### Embodiment 6

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

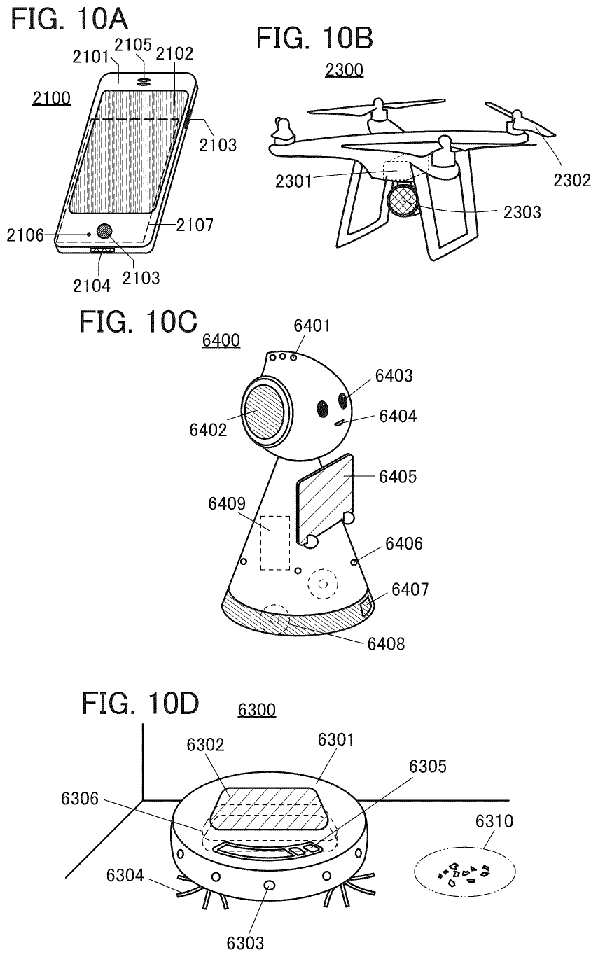

FIG. 10A illustrates an example of a mobile phone. A mobile phone 2100 includes, in addition to a display portion 2102 incorporated in a housing 2101, operation buttons 2103, an external connection port 2104, a speaker 2105, a microphone 2106, and the like. The mobile phone 2100 includes a secondary battery 2107. The use of the secondary battery 2107 including the negative electrode described in Embodiment 1 can result in a high capacity and a structure that can accommodate space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 10B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including the negative electrode described in Embodiment 1 has excellent cycle performance and a high level of safety, and thus can be used safely for a long time over a long period and is preferable as the secondary battery included in the unmanned aircraft 2300.

FIG. 10C illustrates an example of a robot. A robot 6400 illustrated in FIG. 10C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. A secondary battery including the negative electrode described in Embodiment 1 has excellent cycle performance and a high level of safety, and thus can be used safely for a long time over a long period and is preferable as the secondary battery 6409 included in the robot 6400.

FIG. 10D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including the negative electrode described in Embodiment 1 has excellent cycle performance and a high level of safety, and thus can be used safely for a long time over a long period and is preferable as the secondary battery 6306 included in the cleaning robot 6300.

The contents of this embodiment can be combined with the contents of the other embodiments as appropriate.

### Embodiment 7

In this embodiment, examples of devices of space each including the secondary battery of one embodiment of the present invention will be described.

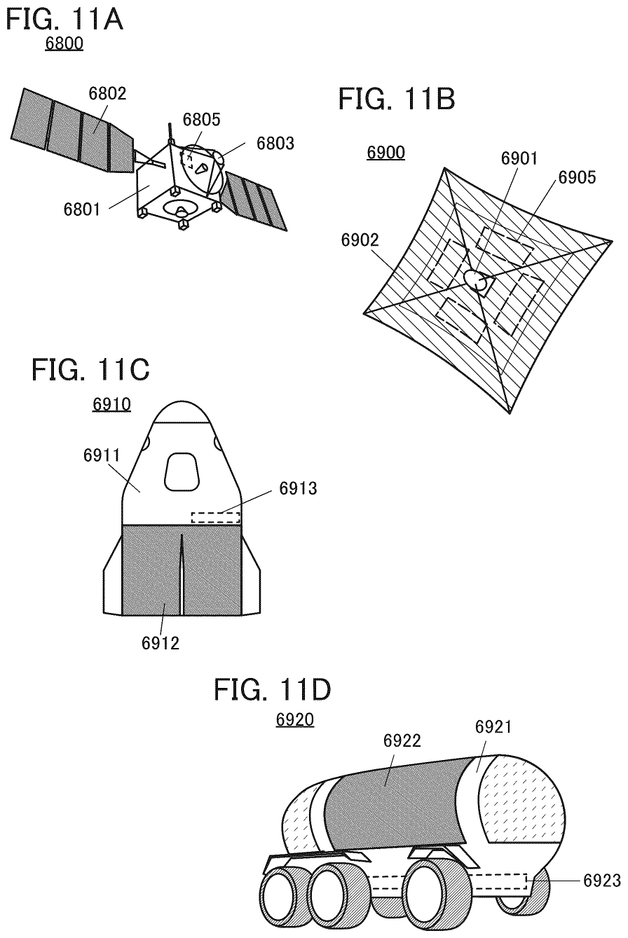

FIG. 11A illustrates an artificial satellite 6800 as an example of a device for space. The artificial satellite 6800 includes a body 6801, a solar panel 6802, an antenna 6803, and a lithium-ion battery 6805. A solar panel is referred to as a solar cell module in some cases.

When the solar panel 6802 is irradiated with sunlight, electric power required for operation of the artificial satellite 6800 is generated. However, for example, in the situation where the solar panel is not irradiated with sunlight or the quantity of sunlight with which the solar panel is irradiated is small, the quantity of generated electric power is small. Accordingly, there is a possibility that a sufficient quantity of electric power required for operation of the artificial satellite 6800 cannot be generated. In order to operate the artificial satellite 6800 even in the situation where the quantity of generated electric power is small, the artificial satellite 6800 is preferably provided with the lithium-ion battery 6805.

The artificial satellite 6800 can generate a signal. The signal is transmitted through the antenna 6803, and the signal can be received by a ground-based receiver or another artificial satellite, for example. When the signal transmitted by the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, when configured to include a visible light sensor, the artificial satellite 6800 can have a function of sensing sunlight reflected by a ground-based object. Alternatively, when configured to include a thermal infrared sensor, the artificial satellite 6800 can have a function of sensing thermal infrared rays emitted from the surface of the earth. Thus, the artificial satellite 6800 can have a function of an earth observation satellite, for example.

FIG. 11B illustrates a probe 6900 including a solar sail as an example of a device for space. The probe 6900 includes a body 6901, a solar sail 6902, and a lithium-ion battery 6905. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 may be designed to be folded into a small size until it goes beyond the earth's atmosphere, and to be unfolded to have a large sheet-like shape as illustrated in FIG. 11B in the space beyond the earth's atmosphere (outer space).

FIG. 11C illustrates a spacecraft 6910 as an example of a device for space. The spacecraft 6910 includes a body 6911, a solar panel 6912, and a lithium-ion battery 6913. The body 6911 can include a pressurized cabin and an unpressurized cabin, for example. The pressurized cabin may be designed so that the crew can get into the cabin. Electric power that is generated by irradiation of the solar panel 6912 with sunlight can be stored in the lithium-ion battery 6913.

FIG. 11D illustrates a rover 6920 as an example of a device for space. The rover 6920 includes a body 6921 and a lithium-ion battery 6923. The rover 6920 may include a solar panel 6922.

The rover 6920 may be designed so that the crew can get into the rover. Electric power that is generated by irradiation of the solar panel 6912 with sunlight may be stored in the lithium-ion battery 6923, or electric power generated by another power source such as a fuel cell or a radioisotope thermoelectric generator, for example, may be stored in the lithium-ion battery 6923.

This embodiment can be freely combined with the other embodiments.

### REFERENCE NUMERALS

104a: mixture, 104b: mixture, 104c: mixture, 105: solvent, 106: slurry, 108: negative electrode, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 322: spacer, 400: negative electrode current collector, 401: graphite, 402: silicon particle, 403: acetylene black, 404: graphene, 405: CNT, 406: space, 407: graphene oxide, 408: graphene oxide, 410: positive electrode current collector, 411: positive electrode active material, 420: separator, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 2100: mobile phone, 2101: housing, 2102: display portion, 2103: operation button, 2104: external connection port, 2105: a speaker, 2106: microphone, 2107: secondary battery, 2300: unmanned aircraft, 2301: secondary battery, 2302: rotor, 2303: camera, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: a speaker, 6405: display portion, 6406: lower camera, 6407: obstacle sensor, 6408: moving mechanism, 6409: secondary battery, 6800: artificial satellite, 6801: body, 6802: solar panel, 6803: antenna, 6805: lithium-ion battery, 6900: probe, 6901: body, 6902: solar sail, 6905: lithium-ion battery, 6910: spacecraft, 6911: body, 6912: solar panel, 6913: lithium-ion battery, 6920: rover, 6921: body, 6922: solar panel, 6923: lithium-ion battery

1. A battery comprising:
a positive electrode active material layer comprising lithium; and
a negative electrode active material layer comprising graphite, silicon, graphene, and a carbon nanotube,
wherein the silicon and the graphene are at least partly in contact with each other, and
wherein the silicon and the carbon nanotube are at least partly in contact with each other.

2. The battery according to claim 1,
wherein a content of the silicon included in the negative electrode active material layer is greater than or equal to 7.5 wt % and less than or equal to 37.5 wt %.

3. The battery according to claim 1,
wherein the negative electrode active material layer comprises a content of a resin material lower than a content of the silicon, or does not comprise a resin material.

4. The battery according to claim 1,
wherein the negative electrode active material layer further comprises acetylene black.

5. The battery according to claim 1,
wherein the silicon included in the negative electrode active material layer is nanosilicon.

6. The battery according to claim 1,
wherein an average particle diameter of positive electrode active material particles included in the positive electrode active material layer is smaller than an average particle diameter of the graphite included in the negative electrode active material layer.

7. A battery comprising:
a positive electrode active material layer comprising lithium; and
a negative electrode active material layer comprising graphite, a particle comprising silicon, graphene, and a carbon nanotube,
wherein the particle comprising silicon and the graphene are at least partly in contact with each other, and
wherein the particle comprising silicon and the carbon nanotube are at least partly in contact with each other.

8. The battery according to claim 7,
wherein the particle comprising silicon comprises oxygen.
